(19) United States
(12) Patent Application Publication
(10) Pub. No.: US 2002/0007313 A1
(43) Pub. Date: Jan. 17, 2002

(54) Credit system

(76) Inventors: Khanh Mai, Alpharetta, GA (US); Roland Noll, Columbia, MD (US); Tom Grimes, Ottawa (CA)

Correspondence Address: DORSEY & WHITNEY, 1001 PENNSYLVANIA AVE., N.W., SUITE 300 SOUTH, WASHINGTON, DC, 20004, US

(21) Appl. No.: 09/902,764

(22) Filed: Jul. 12, 2001

Related U.S. Application Data
(60) Provisional application No. 60/217,721, filed on Jul. 12, 2000.

(51) Int. Cl. G06F 17/60

(52) U.S. Cl. 705/14; 705/26

(57) ABSTRACT

A credit system and method that enables users to purchase and earn credits that may be redeemed to purchase multimedia content transmitted to a client. The credit system and method enables permissive marketing in which third-parties to reward users with credits in exchange for the users performing a requested action. The credit system and method provide a method of rewarding credits that may be used by a user to purchase multimedia content delivered to a client. The method comprises providing a permissive marketing offer. The permissive marketing offer specifies a number of credits that the user will be rewarded for performance of a requested action. The method further comprises the user performing the requested action, validating performance of the requested action, and crediting a user account with the rewarded credits. The credits in the user account may be used by the user to purchase multimedia content.

### CROSS REFERENCE TO RELATED APPLICATIONS

This application hereby claims the benefit of the priority of U.S. Provisional Patent Application, Serial No. 60/217,721, filed Jul. 12, 2000, which is hereby incorporated by reference. This application also hereby incorporates by reference U.S. patent application, Ser. No. 09/835,529, entitled “Channel Dancer” and filed Apr. 17, 2001, U.S. patent application, Ser. No. 09/878,232, entitled “Personal Content Manager” and filed Jun. 12, 2001, U.S. patent application, Ser. No. 09/893,634, entitled “Virtual Multicasting”, and filed Jun. 29, 2001, and U.S. patent application, Ser. No. 09/893,635, entitled “Digital Rights Management”, and filed Jun. 29, 2001.

### BACKGROUND

1. Technical Field

The present invention is related to consumer reward systems, and more particularly to credit and award systems for purchasing pay content available from multiple sources.

2. Description of Related Art

Over the past ten years, the bandwidth capacity available to consumers for receiving content from the Internet and other networks has increased ten-fold and more. The increased bandwidth capacity has enabled consumers to download larger and larger files and other content, including rich media and multimedia content such as audio clips, video clips, songs, programs and movies (collectively, programs or content). This increased bandwidth capacity has increased Internet usage and the potential for enjoyable and productive usage.

Most current reward systems provide purchasing of credit and using the credit to securely purchase goods on the Internet only. However, there are no current consumer reward systems that enable consumers to use credits to purchase multimedia content. Likewise, the current reward systems do not allow for earning of credits through advertising or product promotions (permissive marketing) made available as multimedia content. There is no mechanism available for a user of multimedia content to earn credit that is redeemable towards pay-per-view (PPV), subscription content, products, services, or otherwise. Such users must purchase credits to redeem. In sum, there is no system that brings together the benefits of increased bandwidth multimedia content (“broadband content”) and consumer reward systems to provide a number of benefits to both advertisers and consumers.

### SUMMARY OF THE INVENTION

An advantage of the present invention is that it overcomes the disadvantages and shortcomings of the prior art. Another advantage of the present invention is that it provides a credit system that enables advertisers to distribute advertising costs and to reach more users through permission or permissive marketing. Another advantage of the present invention is that it provides a credit system that tracks data through permissive marketing and relationship building so that both content providers (e.g., advertisers) and broadband distributors are able to understand the exact value and revenue generated by each user. Another advantage of the present invention is that it provides a credit system that includes an award system for advertisers to use for permissive marketing. Through the award system, an advertiser can award users with credits for viewing promotions for their products. Still another advantage of the present invention is that it provides a credit system that validates and tracks users responses to the products in the advertisements. For example, an auto manufacturer can verify that a user has viewed an advertisement for a particular product (car) and also track the user responses to the ad such as a promotion for credits if the user test-drives the car at a local dealer.

Another advantage of the present invention is that it provides a credit system that allows credit awards for actual purchase or deductions for purchase discount. Likewise, the credit system allows credit awards, deductions and transfers. For example, credits may be deducted for inaction. Another advantage of the present invention is that it provides a credit system that allows verification of user and content distributor fulfillment, through a transaction log, for advertisers and on-line distributors. The transaction log provides proof that a distribution partner presented advertisements and that users viewed the advertisements.

Another advantage of the present invention is that it provides a credit system that allows users to purchase credits as a means of purchasing pay content. Another advantage of the present invention is that it provides a credit system that allows users to purchase credits in blocks and through on-line payment avoiding the normal difficulties of small transaction amounts for pay content. Another advantage of the present invention is that it provides a credit system that allows users to buy or transfer credits to other user accounts.

These and other advantages are achieved by a method of rewarding credits that may be used by a user to purchase multimedia content delivered to a client. The method comprises providing a permissive marketing offer. The permissive marketing offer specifies a number of credits that the user will be rewarded for performance of a requested action. The method further comprises the user performing the requested action, validating performance of the requested action, and crediting a user account with the rewarded credits. The credits in the user account may be used by the user to purchase multimedia content.

These and other advantages are achieved by a system comprising the client, the server, and a communication medium enables the client and the server to communicate with each other, wherein the system performs the above method.

These and other advantages are achieved by a method of rewarding credits that may be used by a user to purchase multimedia content delivered to a client. The method comprises selecting a permissive marketing offer that includes an offer of a credit award in exchange for the user viewing content, transmitting the content to the client for display, displaying the content on the client, the client generating an event, the client communicating the event to a server remote from the client, the server validating the event, and the server crediting the credit award to a user account. The event is proof that the content has been displayed.

These and other advantages are achieved by a method of rewarding credits that may be used by a user to purchase multimedia content delivered to a client. The method comprises broadcasting an educational program, wherein the educational program specifies a number of credits that may be earned by a first user, displaying the educational program, and transferring the specified number of credits from a second user account to a first user account so that the first user may use the credits to purchase multimedia content.

These and other advantages are achieved by a computer-readable medium comprising instructions for rewarding credits that may be used by a user to purchase multimedia content delivered to a client, by displaying a permissive marketing offer. The permissive marketing offer specifies a number of credits that the user will be rewarded for performance of a requested action. The computer-readable medium further comprises instructions for generating an event and transmitting the event to a server for validation of the event and rewarding of the specified number of credits to a user account. The event indicates that the user has performed the requested action.

These and other advantages are achieved by a computer-readable medium comprising instructions for rewarding credits that may be used by a user to purchase multimedia content delivered by a server, by transmitting a permissive marketing offer to a client. The permissive marketing offer specifies a number of credits that the user will be rewarded for performance of a requested action. The computer-readable medium further comprises instructions for receiving an event, validating the event, whereby the authenticity of the event is verified, and rewarding the specified number of credits to a user account. The event indicates that the user has performed the requested action.

These and other advantages are achieved by a card for use in a multimedia content delivery system that delivers multimedia content to clients and in which credits may be used by a user to purchase multimedia content for viewing, the card including a balance of credits, maintained in electronic form, that indicates how many credits that are available to the user for purchasing multimedia content and a ID number that identifies the card.

### BRIEF DESCRIPTION OF THE DRAWINGS

The detailed description will refer to the following drawings, in which like numbers and letters refer to like items, and in which:

FIG. 1 is a schematic diagram illustrating an exemplary content delivery system with which the present invention may be used.

FIGS. 2A and 2B are block diagrams illustrating exemplary hardware components that support and enable an embodiment of the credit system.

FIG. 3 is a block diagram illustrating exemplary components of an embodiment of the credit system.

FIG. 4 is a flowchart illustrating a method of purchasing content with the credit system.

FIGS. 5A-B are flowcharts illustrating exemplary methods of permissive marketing using the credit system.

FIG. 6 is a flowchart illustrating an exemplary method of permissive marketing using the credit system for an infomercial.

FIG. 7 is a block diagram of an exemplary credit system.

FIGS. 8-11 are flowcharts illustrating exemplary methods of permissive marketing.

### DETAILED DESCRIPTION OF THE INVENTION

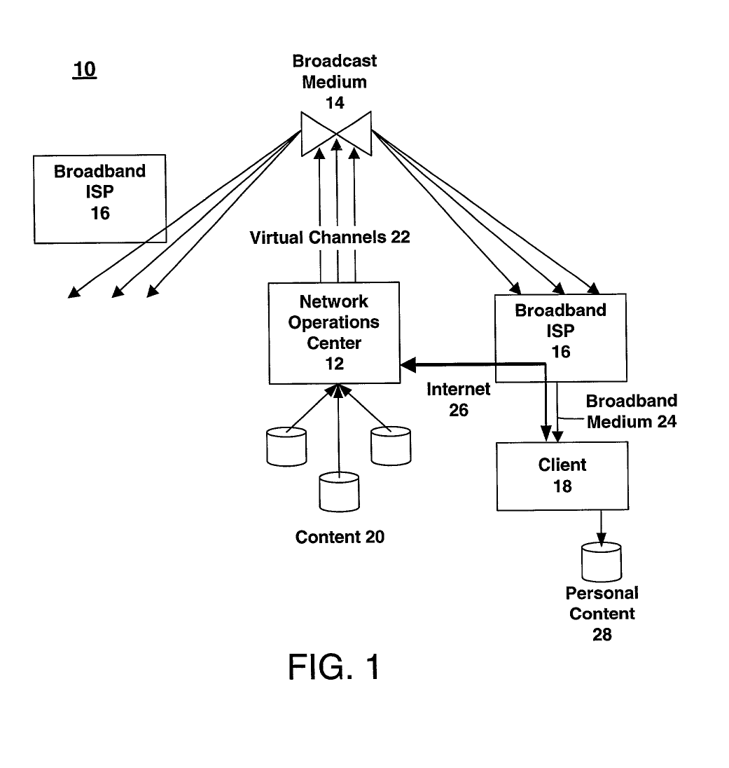

The present invention comprises a credit system and method that provides an online payment system for purchasing of credits and a mechanism for earning credits. The credits, whether purchased or earned, may be used (i.e., on-line as on-line cash) to pay for content (e.g., provided by a broadband content delivery system, such as shown in FIG. 1, an Internet Service Provider (ISP), a direct-to-home content provider, or any other content source). In addition, the credit system enables advertisers or vendors to promote their products or services through permissive marketing by awarding credits to users that view their ads, test their products or purchase their products on-line, among other things.

FIG. 1 illustrates a broadband content delivery system 10 with which the present invention may be used to purchase and earn credits that may be used to access and purchase broadband content delivered by the system 10 and other content (e.g., digital music or video files from websites on the Internet). The broadband content delivery system 10 is exemplary and the credit system of the present invention may be used with any content delivery system and with content delivered in any manner. The illustrative broadband content delivery system 10 comprises a signal origination point 12, a transmission medium 14 (e.g., a satellite or a landline), one or more service providers 16, and one or more clients 18. The client 18 typically includes a user machine (e.g., a PC) that includes resident client software. The client software enables access to the broadband content, supports the broadband content delivery system 10 and the credit system. Indeed, the client software is part of the digital rights management system.

Typically, high bandwidth content 20 (e.g., video, audio and web data) is transmitted from a signal origination point 12 such as a Network Operations Center (“NOC”) on high-resolution (“high rez”) virtual channels 22. The NOC may include a number of servers that support the credit system. The transmission medium 14 is satellite, ether and/or landline, or a combination thereof. The content 20 is received by a service provider 16, typically an edge-of-net broadband Internet service provider (“ISP”) and transmitted over a broadband medium 24, such as a digital subscriber line (“DSL”) or coaxial cable, to a client 18. The broadband medium connection may be maintained or “open” continuously or substantially maintained continuously. Two-way communications between the client 18 and the NOC 12 are maintained over the Internet 26. Content may also be received by the client 18 directly from the Internet 26 via the ISP 16.

In addition to transmitting the content on virtual channels 22, the broadband content delivery system 10 also transmits a control channel (signal) that is received by the client 18. The control channel contains information and instructions that help enable the client 18 (i.e., the client software) to access and control the content 20 provided by the broadband content delivery system 10. The control channel is used to issue commands or directives to the client 18. These commands or directives may result in feedback or a report back from the client 18 to the NOC 12 via the Internet. Significantly, the control channel is used to deliver program descriptors or “program nuggets”, and digital messages, such as those described below. For example, a digital message may report an invalid digital certificate to the client 18.

Not necessarily all clients 18 of the broadband content delivery system 10 will have the bandwidth capability or resources to receive the high bandwidth on high rez virtual channels 22 (e.g., 512 Kbps or more). Accordingly, in addition to high bandwidth content 20, the broadband content delivery system 10 provides low bandwidth content 20 on low-resolution (“low rez”) virtual channels 22 (e.g., approximately 200 Kbps) or other communications bandwidth to accommodate these clients. Consequently, when a client 18 signs-on, the broadband content delivery system 10 preferably conducts a bandwidth test to measure client's 18 bandwidth capability (“available bandwidth”). Usually, the available bandwidth is calculated as the maximum bandwidth content that the client 18 can consistently receive.

Referring back to FIG. 1, content 20 may be transmitted or broadcast (broadcast and transmitted is meant herein to include any method of delivering content, including for example, multicasting, unicasting, direct transmission, or file download) by the NOC 12 on the virtual channels 22 as real-time multicast or unicast streams. A multicast stream comprises streaming content that is directed to and available to multiple clients 18 that join a multicast group. A unicast stream comprises streaming content that is directed to and available to one client 18 at a time; unicast content must be replicated for each client 18 that receives it. Furthermore, additional content 20 may be provided by third-parties as on-demand broadband content selected from the Internet (“edge-of-net”) by a user at the client 18. For example, an ISP 16 may provide the edge-of-net content. Likewise, the user may store selected content, such as portions of the real-time multicast or unicast streams in a local cache at the client 18. This stored or personal content 28 may be kept on a user machine hard-drive or other storage medium.

The content broadcast on the virtual channels as real-time multicast or unicast streams includes many types of restricted or purchased content, including pay-per-view, pay-per-download, pay-per-play, pay-per-interaction and subscription (hereinafter, collectively “PPV”) content. The credit system is utilized to purchase the PPV content. As is described in more detail below, a user may purchase or earn credit that then may be used to pay for the PPV content. The credit system manages the crediting and debiting of the credit.

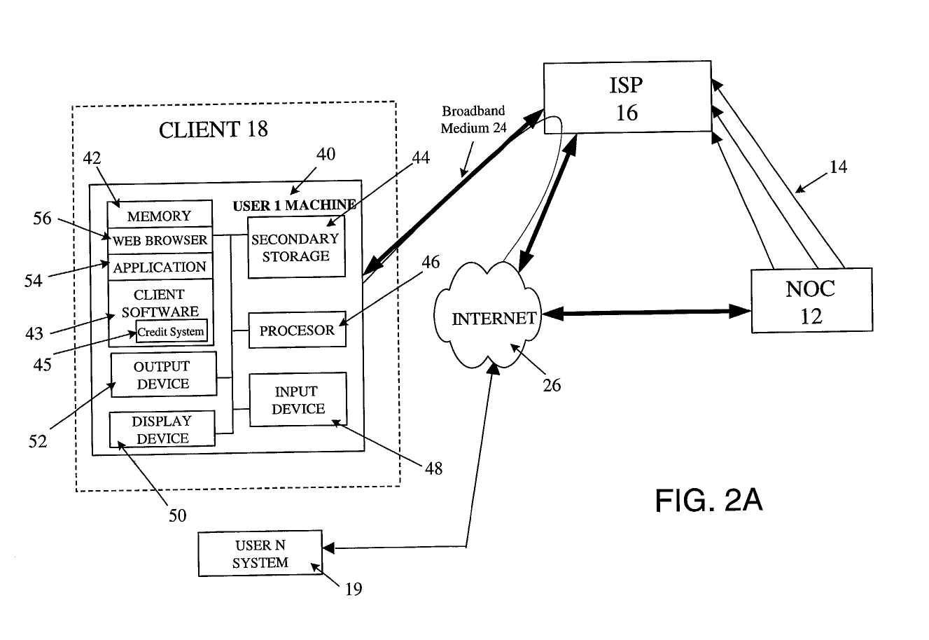

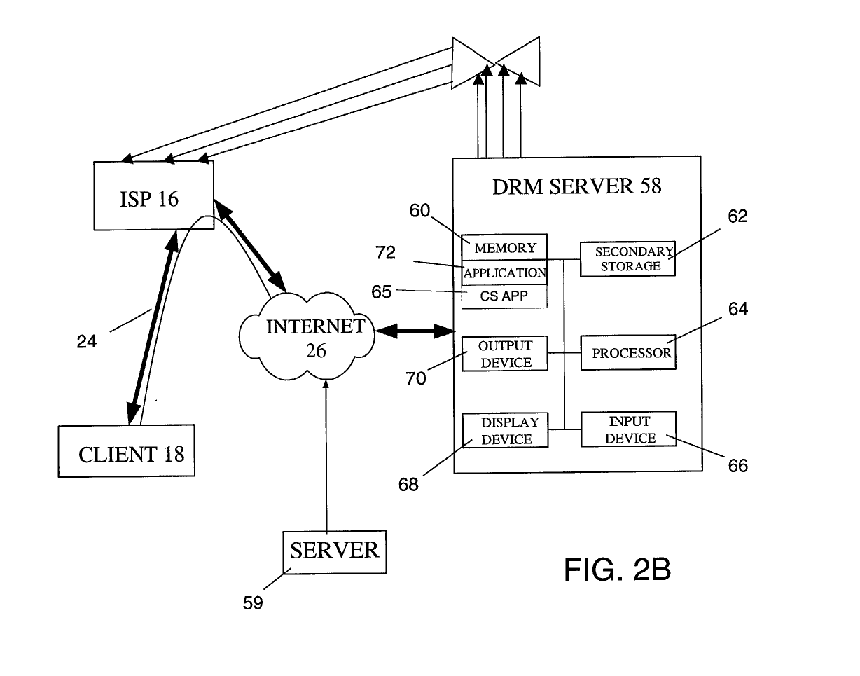

FIGS. 2A and 2B are block diagrams illustrating exemplary hardware components of the exemplary broadband content delivery system 10, or other content delivery system, that may be used for implementing the credit system. FIG. 2A includes the client 18, comprising a user machine 40 connected with a network such as the Internet 26, providing network connections to the NOC 12 and the ISP 16 (or other content source). The user machine 40 includes the client software 43 that the user has downloaded from an ISP 16 or portal or otherwise obtained (e.g, by loading from a CD-ROM or magnetic disk or by being pre-installed on the user machine 40). As mentioned, the client software 43 supports the broadband content delivery system 10 and is executed to perform functions of the credit system. Preferably, the client software 43 includes a credit system module 45 that is programmed to perform the credit system methods (or portions thereof) described below. Other clients 18, such as client 19 may also be connected with network and may include the same components as client 18.

The user machine 40 illustrates typical components of a user machine. The user machine 40 typically includes a memory 42, a secondary storage device 44, a processor 46, an input device 48, a display device 50, and an output device 52. Memory 42 may include random access memory (RAM) or similar types of memory, and it may store one or more applications 44, including client software 43, and a web browser 56, for execution by processor 46. The secondary storage device 44 may include a hard disk drive, floppy disk drive, CD-ROM drive, or other types of non-volatile data storage. The local cache that includes a user's personal content 28, may be stored on the secondary storage device 44.

The processor 46 may execute client software 43 (including the credit system module 45) and other applications 44 stored in memory 42 or secondary storage 44, or received from the Internet or other network 26. The processor 46 may execute client software 43, including the credit system module 45, in order to provide the functions described in this specification including the credit system functions described below. The input device 48 may include any device for entering information into the user machine 40, such as a keyboard, mouse, cursor-control device, touch-screen, infrared, microphone, digital camera, video recorder or camcorder. The display device 50 may include any type of device for presenting visual information such as, for example, a computer monitor or flat-screen display. The output device 52 may include any type of device for presenting a hard copy of information, such as a printer, and other types of output devices include speakers or any device for providing information in audio form.

The web browser 56 is used to access the client software 43 and display interface screens through which the user can manage and access the credit system and the broadband content broadcast by the broadband content delivery system 10 or otherwise obtained from a content source. The web browser 56 also is used to access the NOC 12, the ISP 16, and third-party websites that include other content (e.g., digital music and video files). Examples of web browsers 56 include the Netscape Navigator program and the Microsoft Internet Explorer program. The content broadcast on virtual channels and received by the client 18 may be displayed through the web-browser 56. The content may include “links”, for example, HyperText Transport Protocol (“HTTP”) hyperlinks to other content and/or Internet websites. Multimedia applications such as Microsoft Media Player™ and RealPlayer™ may be used to enable viewing of the real-time multicast stream. Any web browser, co-browser, or other application capable of retrieving content from a network (any wireline or wireless network may be used) and displaying pages or screens may be used.

Examples of user machines 40 for interacting within the broadband content delivery system 10 include personal computers, laptop computers, notebook computers, palm top computers, network computers, Internet appliances, or any processor-controlled device capable of executing a web browser 56 or other type of application for interacting with the broadband content delivery system 10 or other content source.

The NOC 12, or other content source, may comprise a plurality of servers. FIG. 2B illustrates typical hardware components of a credit system server 58. The credit system may be implemented with one credit system server 58 or with a plurality of credit system servers 58. Other servers at the NOC 12, at the ISP 16, or other content source, may have similar or the same hardware components. The credit system server 58 typically includes a memory 60, a secondary storage device 62, a processor 64, an input device 66, a display device 68, and an output device 70. The memory 60 may include RAM or similar types of memory, and it may store one or more applications 72 for execution by processor 64. The applications 72 include a credit system application 65 (or module) that is programmed to perform the credit system methods (or portions thereof) described below.

The secondary storage device 62 may include a hard disk drive, floppy disk drive, CD-ROM drive, or other types of non-volatile data storage. The processor 64 executes credit system application 65, and other application(s) 72, that are stored in memory 60 or secondary storage 62, or received from the Internet 26 or other network. The input device 66 may include any device for entering information into credit system server 58, such as a keyboard, mouse, cursor-control device, touch-screen, infrared, microphone, digital camera, video recorder or camcorder. The display device 68 may include any type of device for presenting visual information such as, for example, a computer monitor or flat-screen display. The output device 70 may include any type of device for presenting a hard copy of information, such as a printer, and other types of output devices include speakers or any device for providing information in audio form.

The credit system server 58 may store a database structure in secondary storage 62, for example, for storing and maintaining information regarding the broadband content delivery system 10 and the clients 18. For example, it may maintain a relational or object-oriented database, or any other type of database, for storing information concerning users, the access rights of the users and their account status. Likewise, it may maintain a relational or object-oriented database, or any other type of database, for storing information concerning users' transactions, including total credits, PPV debits, credit purchases and earned credits. As mentioned above, processor 46 and/or processor 64 may execute one or more software applications 44 or 72, such as credit system module 45 and credit system application 65, in order to provide the credit system and methods, and other functions described in this specification. The processing may be implemented in software, such as software modules, for execution by computers or other machines. Preferably, the credit system module 45 is a module or component of the client software 43.

The processing by processor 46 and/or processor 64 may provide and support pages, windows and menus (collectively, “screens”) described in this specification and otherwise for display on display devices associated with the client 18. The term “screen” refers to any visual element or combinations of visual elements for displaying information or forms; examples include, but are not limited to, graphical user interfaces on a display device or information displayed in web pages or in pop-up windows/menus on a display device. The screens may be formatted, for example, as web pages in HyperText Markup Language (HTML), Extensible Markup Language (XML) or in any other suitable form for presentation on a display device depending upon applications used by users to interact with the broadband content delivery system 10 or other content source.

Although only one credit system server 58 is shown, broadband content delivery system 10 may use multiple servers 59 as necessary or desired to support the users and may also use back-up or redundant servers to prevent network downtime in the event of a failure of a particular server. In addition, although the user machine 40 and credit system server 58 are depicted with various components, one skilled in the art will appreciate that the user machine 40 and the credit system server 58 can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as user machine 40 and credit system server 58, to perform a particular method or implementation, such as those described below.

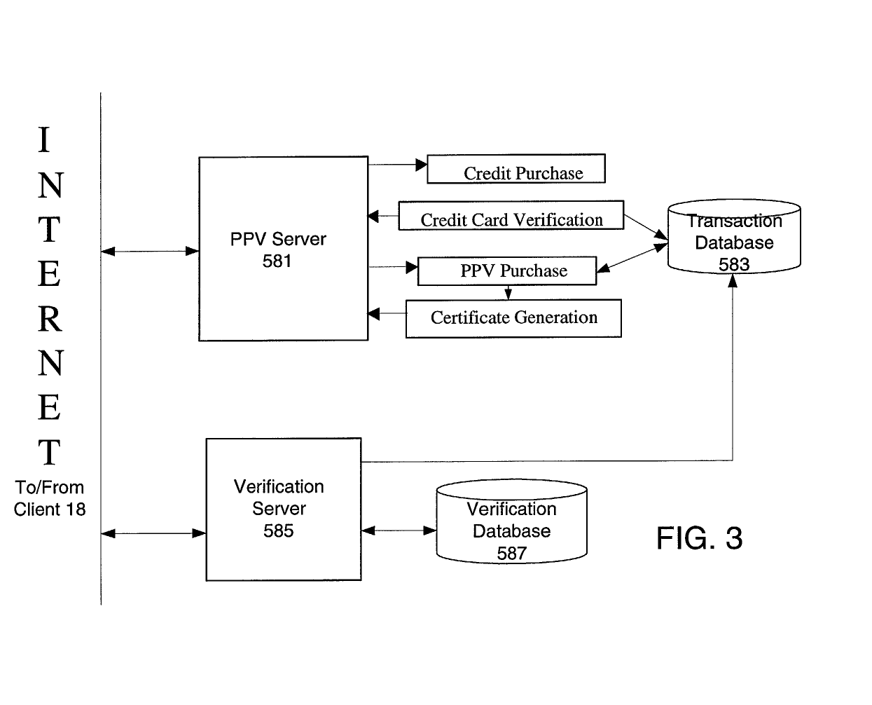

One credit system server 58 may be a PPV server 581. As shown in FIG. 3, the PPV server 581 may also interact with the client 18 though the Internet 26. When the user at the client 18 orders PPV content, a PPV order is preferably sent to the PPV server 581 via the Internet 26, e-mail, telephone, facsimile or other communication medium. The PPV order comprises a program ID that identifies the PPV content and a cost (in credits) for the PPV content. Alternatively, the PPV order may not include the cost and the PPV server 581 may access a database (not shown) that stores the cost for the PPV content and determine the cost of the ordered PPV content using the program ID. Some PPV content may be ordered for multiple viewings, downloads or as a subscription. For example, the user may order two or more viewings of a program or a day, week, month, season or year of a program. If the PPV content is ordered for multiple viewings or as a subscription, the PPV order comprises the number of viewings or the length of the subscription.

The PPV server 581 accesses a transaction database 583, as seen in FIG. 3, which stores user entries containing information concerning users' transactions, including the total number of credits for each user, PPV debits, credit purchases and earned credits. The transaction database 583 may be maintained in the PPV server 581 secondary storage 62, as described above, or in a remotely located storage. Users may increase their total number of credits by purchasing credits or, as discussed in detail below, by earning credits. A user may purchase credits by accessing a credit-purchasing screen (not shown), available on-line, with the web browser 56. For example, the client 18 may contact the PPV server 581, or other credit system server 58, via the Internet 26, retrieve the credit-purchasing screen, enter payment information (e.g., a credit or debit card number) in data fields on the credit purchasing screen and submit the payment information to the PPV server 581, or other credit system server 58, via the Internet 26 or other communication medium. The submitted information and selected credit purchase is then preferably used to update the user entry in the transaction database 583.

The credit-purchasing screen preferably offers incremental credit purchasing (e.g., $5, $10 or $20 increments). By allowing the user to purchase credits in advance of ordering PPV content, the credit system may avoid the hassle of the user having to use the credit purchase process each time the user orders PPV content. This also allows the credit system to reduce the number of payment requests submitted to third-party creditors (e.g., credit card companies, banks, etc.), reducing transaction costs and overhead.

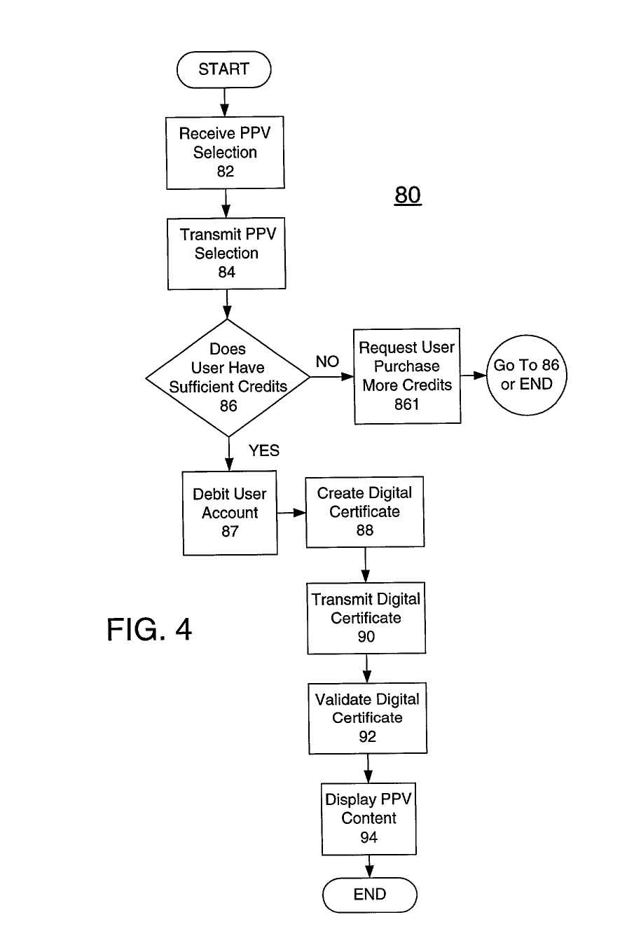

FIG. 4 illustrates an exemplary method 80 of ordering PPV content using the credit system. The method 80 preferably comprises: receiving a PPV selection 82, transmitting the PPV selection 84; determining if the user has sufficient credits 86; debiting user account 87; creating a digital certificate 88; transmitting the digital certificate 90; validating the digital certificate 92; and, displaying the PPV content 94. The client software 43 receives a PPV selection when a user selects available PPV content. The user's selection may be made through a graphical user interface (“GUI”) or screen, accessed through the web browser 56, that presents one or more content items available from the system 10 or other content source. An example of such screens are shown in the above-reference related application “Personal Content Manager.” Transmitting the PPV selection 84 preferably comprises the client 18 (e.g., the client software 43) sending a PPV order, corresponding to the user's selection, to the PPV server 581 (or other content source server) via the Internet 26 or other communication medium. The PPV order preferably includes a program ID that identifies the selected PPV content and, alternatively, the price of the PPV content.

The PPV server 581 receives and processes the PPV order. The processing comprises the PPV server 581 accessing the transaction database 583 and determining if the user has sufficient credits 86 for the selected PPV content, as described above. If the user does not have sufficient credits, the method 80 may include requesting the user to purchase more credits 861, as described below. If the user does not purchase more credits, the method 80 ends and the PPV order is deleted. If the user does purchase more credits, step 86 is repeated. If the user does have sufficient credits, the PPV server debits 87 the user's account balance of credits by the cost in credits of the PPV content, as indicated in the PPV order or otherwise determined by the PPV server 581.

The PPV server 581 (or other server) preferably then creates 88 a digital certificate. The digital certificate comprises a digital certificate serial number, the program ID of the PPV content, the duration of the PPV content and the number of viewings or length of subscription purchased. The digital certificate is preferably stored in the secondary storage 62 of the PPV server 581, or other NOC server with a hardware profile of the client 18. The digital certificate is described in more detail in the above-referenced related application “Digital Rights Management”. An encrypted copy of the digital certificate is transmitted 90 to the client 18. The client software 43 preferably includes a key for decrypting the digital certificate. When the user attempts to view the PPV content the client 18 checks for the digital certificate by seeking to match the program ID of the PPV content to the program ID in the digital certificate. If no digital certificate is found, the client 18 will not display the PPV content.

If a digital certificate is found, the client 18 attempts to validate 92 the digital certificate. Validating 92 the digital certificate preferably comprises the client software 43 determining the digital certificate serial number from the digital certificate and transmitting the digital certificate serial number and a new hardware profile of the client 18 to the PPV server 581 and the PPV server determining if the new hardware profile matches the hardware profile stored with the digital certificate identified by the digital certificate serial number. If the digital certificate is validated, an encryption key for decrypting the PPV content is transmitted to the client 18. The validating process is described in more detail in the above-referenced related application “Digital Rights Management”. Once the PPV content is decrypted, the PPV content may be displayed 94 as streaming video on the user machine display 50.

As discussed above, a user may also earn credits. The credit system provides a unique reward system whereby third-parties may purchase credits for or give credits to a user as a reward for some action taken by the user. This process is referred to as permissive marketing. Consequently, the user may earn credits simply by completing an action requested by a third-party (e.g., a vendor or another user) that is participating in the credit system. For example, the action may be watching an infomercial, or any other content, broadcast on a virtual channel as a real-time multicast or unicast stream, or otherwise received by a user. The action may be providing information or data. Likewise, the action may be test-driving a vehicle or purchasing a vehicle at a participating automobile dealer or taking a flight on a participating airline. The action may be virtually anything that a third-party wants to reward the user for completing. The action may include inaction or not doing something, such as a credit award for not smoking or not playing a game, or anything for which the third-party wants to reward the user.

Accordingly, the credit system may also include a verification server 585, as illustrated in FIG. 3, that supports permissive marketing and enables users to earn credits. Alternatively, one credit system server 58 may perform all of the functions of the PPV server 581 and the verification server 585. The verification server 585 processes communications called “events” that indicate the completion of an action for which a user earns credits and adds credits to the user's total credits in the transaction database 583. The verification server 585 accesses a verification database 587 that includes information on the amount of credit earned for each action and information on participating third-parties who are billed or debited for the earned/rewarded credits. The verification database 587 may also include information for checking the events to verify performance of the requested action. The verification database 587 may be maintained in the verification server 585 secondary storage 62, as described above, or in a remotely located storage.

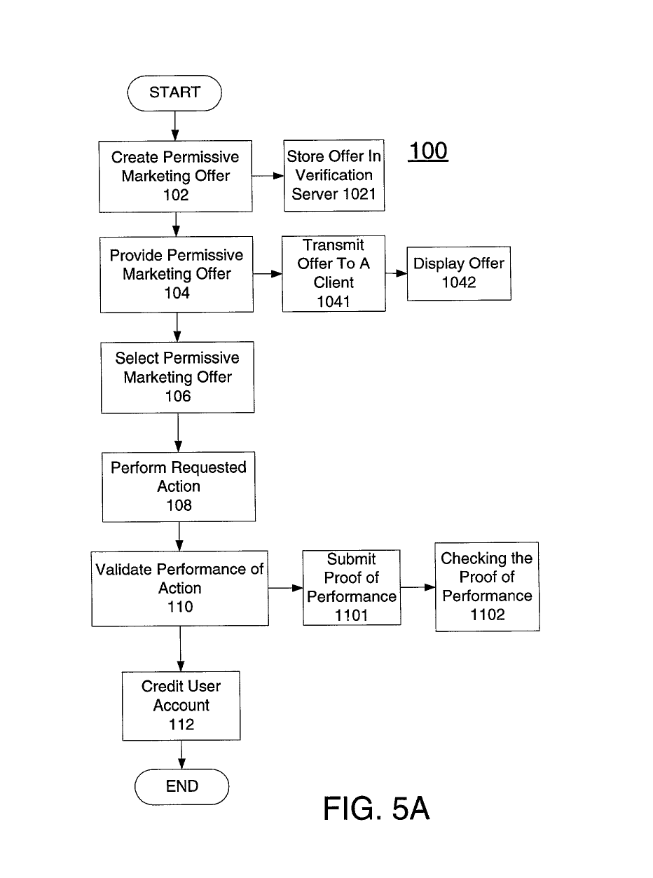

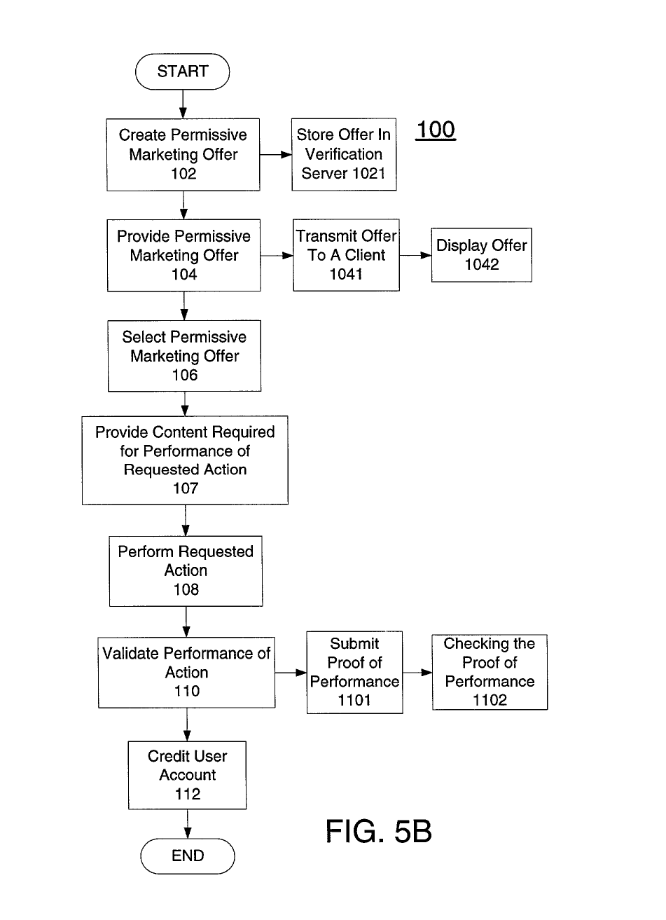

FIGS. 5A-5B illustrates a method of permissive marketing supported by the credit system. As shown in FIG. 5A, a method 100 of permissive marketing may comprise the steps of: creating a permissive marketing offer 102; providing the permissive marketing offer 104; selecting the permissive marketing offer 106; performing a requested action 108; validating performance of the requested action 110; and, crediting user account with a credit award 112. A third-party preferably creates 102 the permissive marketing offer. The permissive marketing offer preferably includes a requested action and a corresponding credit award provided upon completion of the requested action. As shown, the permissive marketing offer is preferably stored 1021 in the verification database 587, so that performance of the requested action may be validated and the proper credits awarded.

Providing the permissive marketing offer 104 preferably comprises a third-party, NOC, ISP, or other content source server transmitting 1041 the permissive marketing offer to a client 18 and the client 18 displaying 1042 the permissive marketing offer (e.g., on the display device 50). Preferably, the client software 43 receives the permissive marketing offer via the Internet 26 and displays the permissive marketing offer using the web browser 56. A user may then select 106 the permissive marketing offer by selecting a hyperlink in the displayed permissive marketing offer, for example. The selecting step 106 preferably creates a contract between the user and the third-party whereby the user agrees to perform the requested action and the third-party agrees to provide the credit award (e.g., 100 credits). The selecting step 106 may alternatively be performed after performance of the requested action as part of the validating step 110 (see below).

The user performs the requested action 108. Preferably, the performing step 108 provides the user with some mechanism of proof of performance of the requested action. For example, the proof may be data, a file, a code, a permissive marketing digital certificate, a key-number or a key-word that is provided only upon completion of the requested action. The proof may be provided directly or indirectly by the third-party. For example, the proof may be contained with the last packet of a stream of packets that comprises content (e.g., an advertisement) that a user must view to complete the requested action.

Validating performance of the requested action 1 10 preferably comprises submitting the proof of performance 1101 and the checking the proof of performance 1102. The submitting step 1101 preferably comprises client software 43 (e.g., the credit system module 45) generating an event with the proof of performance and transmitting the event to the verification server 585. If the user possesses the proof, the client software 43 may require the user to enter the proof so that the client software 43 may generate the event. The event preferably comprises a file or simply data that includes the proof of performance. The checking step 1102 comprises the verification server 585 receiving and validating the received event against the required proof in the verification database 587. Alternatively, the checking step 1102 may be performed by the client software 43 which checks the submitted proof against the permissive marketing offer (if the offer contains the requirement for proof) and transmitting the validated event to the verification server 585, which then just performs the crediting step 112.

Crediting the user account 112 preferably comprises the verification server 585 determining the credit award for the permissive marketing offer, from the verification database 587, and crediting the user's credit balance in the transaction database 583 with the appropriate earned credits (e.g., 100 credits). The verification server also debits the earned credits from the third-party's account in the verification database or bills the third-party for the earned credits.

As shown in FIG. 5B, the method 100 may also comprise the step of providing content required for performance of the requested action 107. If the requested action requires that the user view or listen to certain content (e.g., an advertisement), the content must be transmitted to the client 18 and displayed or output. Therefore, the providing step 107 preferably comprises a third-party, NOC, ISP, or other content source server transmitting the required content to the client 18 and the client 18 displaying or outputting the content. The content may be provided via virtual channels of the system 10, or otherwise.

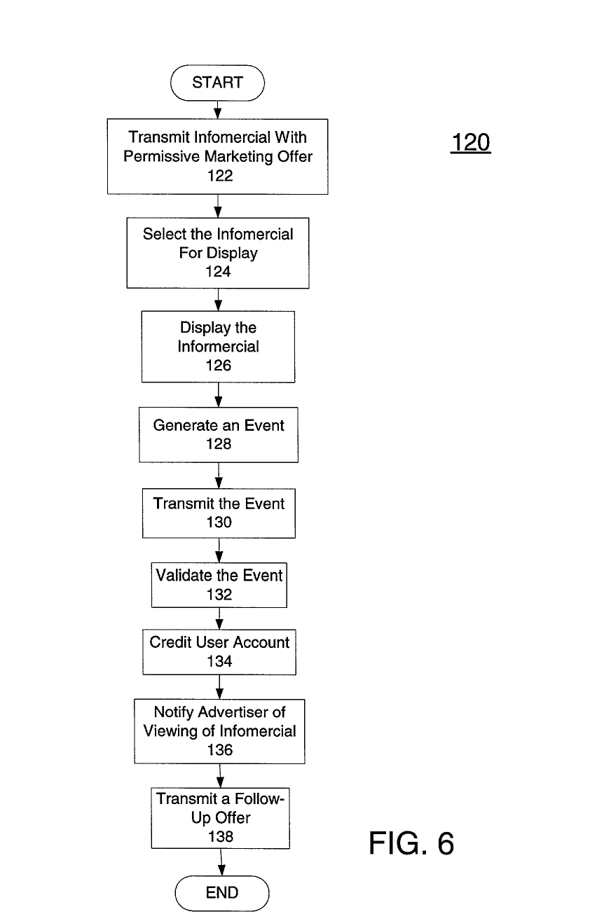

FIG. 6 illustrates a specific example of credit system processing of a permissive marketing offer. In this example, watching an infomercial is the action requested by an advertiser in the permissive marketing offer in order to earn a credit award of one hundred (100) credits. The infomercial is a real-time multicast stream broadcast on a virtual channel by the NOC 12 to the client 18. The infomercial may alternatively be directly transmitted to the client 18 (e.g., via the Internet 26 or landline link to a ISP 16 or directly to the client 18). The infomercial in this example includes the permissive marketing offer (e.g., the offer is displayed in a banner or border ad surrounding a screen that displays the infomercial). The exemplary method of permissive marketing 120 comprises the steps of: transmitting the infomercial with a permissive marketing offer 122; the client 18 selecting the infomercial for display 124; the client 18 displaying the infomercial 126; the client 18 generating an event 128; the client 18 transmitting the event 130; the verification server 585 validating the event 132; the verification server crediting the user account 134; notifying the advertiser of the viewing of the infomercial 136; and, transmitting a follow-up offer 138.

As noted above, the transmitting step 132 may comprise the NOC 12, ISP 16, or other content source broadcasting, directly transmitting, or otherwise communicating the infomercial and the permissive marketing offer to the client 18. The selecting step 124 preferably comprises the client software 43 determining to receive the infomercial based upon a user input, such as a user selection from a GUI or other screen offering the infomercial (not shown). The selecting step 124 may comprise the client software 43 storing the permissive marketing offer (e.g., in memory 42) and/or communicating acceptance of the offer to the verification server. Once selected, the client 18 begins receiving the stream of packets that comprise the infomercial. If the user immediately views the infomercial, the client software 43 preferably de-crypts the packets of the infomercial as they are received and displays the infomercial 126 on the display device 50. The user may also decide to temporarily store the infomercial in local secondary storage 44 (e.g., a local hard drive).

Either way, when the last packet of the infomercial is de-crypted and viewed, the client software 43 (e.g., the credit system module 45) generates an event 128 indicating completion of the requested action (viewing the infomercial) and transmits the event 130 to the verification server 585 via the Internet 26 or other communication medium. The client software 43 may know to generate the event based on data (e.g., a program ID) in a stream header included in the infomercial stream that matches data (e.g., the program ID) in the stored permissive marketing offer. Alternatively, the client software 43 may be triggered to generate this event based on, for example, an instruction received from the verification server 585, sent over the control channel or otherwise, an instruction included in a packet header in the infomercial packet stream or an instruction generated when the user selected the infomercial. Other means of instructing the client software 43 to generate the event may be used.

The event is validated 132 and the user account is credited 134 as described above (with reference to FIG. 5A). The verification server 585 preferably performs the notification step based on, for example, instructions in the event or stored in the verification database 587. The advertiser may want to transmit a follow-up offer 138, such as a follow-up permissive marketing offer, to the user. The transmitting step 138 may comprises the advertiser transmitting (e.g., through the NOC 12 or directly via the Internet 26) a permissive marketing offer related to the services or product that was the subject of the infomercial. For example, if the infomercial was about a grill (e.g., the George Foreman ® Grill), the follow-up permissive marketing offer may offer a certain amount of credits if the user purchases the grill.

As seen and described above, a plurality of credit system servers 58 at the NOC (or elsewhere) may perform the functions and run applications that provide and execute the credit system. Likewise, multiple databases may be utilized to support the credit system and these servers. Consequently, in the above-described embodiment the credit system is provided by a plurality of servers, and associated databases, that provide a number of functions.

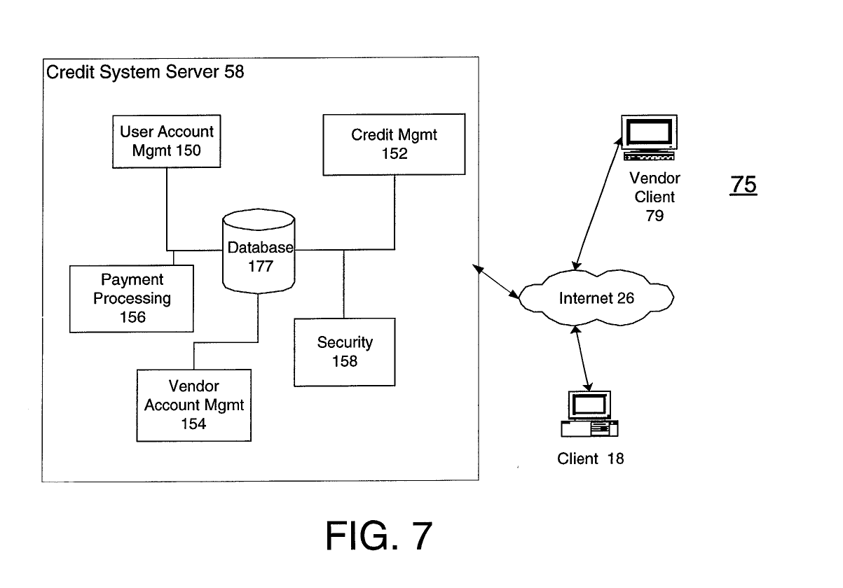

Alternatively, as mentioned above, a single credit server 58 and associated database(s) may perform the functions and run applications that provide and execute the credit system. FIG. 7 illustrates an exemplary credit system 75 that includes a single credit system server 58, a plurality of software applications or modules 72 of the credit system application 65 that provide some or all of the above-described functions (and others), and an associated database 77 that supports the credit system 75. The applications or modules 72 may include a user account management module 150, a credit management module 152, an advertiser or vendor (collectively, “vendor”) account management module 154, a payment processing module 156 and a security module 158.

The user account management module 150 (hereinafter, “user account mgmt”) manages the creation of users' accounts as well as provides GUIs or screens enabling account maintenance. Preferably, the user account mgmt 150 creates a user account when a user first loads the client software 43 on the client 18 and registers with the client system 75. In an embodiment, the user account mgmt 150 receives a hardware profile of the client 18 and other user information (e.g., name, address, email address, credit card information, login ID, password) entered by the user and stores the hardware profile and the information in the database 77. The user account mgmt 150 and/or the client software 43 may request that user enter the user information, for example, by prompting the user to enter the user information through a screen (e.g., web page(s)) with appropriate data fields or a similar interface.

The user account mgmt 150 may also keep a record of the user's transactions in the database 77. This transaction history may include every user transaction (e.g., every item of content viewed, downloaded or recorded, types of content selected, amount of time spent watching content, permissive marketing/promotional offers accepted and executed) or a subset of user transactions, such as type of content viewed or most recent transactions. The user account mgmt 150 may also maintain the user service level, where there is a plurality of different service levels defining types of services and content, for example, offered to the user. The user account mgmt 150 preferably also upgrades, deletes, restricts or limits user accounts, when requested by a user or by an administrator.

The user account mgmt 150 preferably works with the credit management module 152 to process credit transactions for user accounts. The credit management module 152 (hereinafter, “credit mgmt”) maintains credit information of accounts in the database 77 and executes credit transactions for users and advertisers or vendors. The credit information includes account credit balances, account credit transaction records and credit card information. The credit information may be stored in a separate memory or storage device. The account credit balances are the total amount of credits that the user, advertiser or vendor currently has, which may be affected by such transactions as: PPV content purchases, credit transfers to other accounts, other purchases (e.g., debiting 100 credits in exchange for a product rebate or savings on a product purchase) and other debits; or, credit rewards, credit transfers from other accounts and other credits. The account credit transaction records are a history of the aforementioned transactions.

With regard to transactions, the credit mgmt 152 receives instructions (e.g., from the vendor account management module 154 or payment processing module 156) including the user ID(s) or vendor ID(s) identifying the appropriate account(s), the type of transaction (e.g., purchase, transfer, reward, etcetera) and the amount of credits to be debited or credited. The instructions may be stored on the database 77 and linked to a permissive content offer. Alternatively, the instructions may be contained in an event transmitted to the credit system server 58 from the client 18, upon completion of a requested action. Once the appropriate account has been identified, the credit mgmt 152 executes the instructions. If insufficient credits are available to perform the transaction, the credit mgmt 152 generates and communicates an error message to the appropriate parties (e.g., to a user's client 18 for display to the user if the user has insufficient credits to purchase a PPV content item).

The vendor account management module 154 (hereinafter, “vendor mgmt”) manages advertiser and vendor account information. The advertiser and vendor account information is similar to the user information managed by the user account mgmt 150 and the vendor mgmt 154 performs functions similar to the user account mgmt 150. As with a user, when an advertiser or vendor loads vendor software on a vendor client 79 (may have same or similar components as client 18 described above) and registers with the credit system 75, the vendor software creates a hardware profile and communicates it to the vendor mgmt 154, along with vendor information (e.g., name, address, email address, login ID, password and payment method (credit card, etc.)).

In addition to functions described above for the user account mgmt 150, the vendor mgmt 154 may also maintain such information as the vendor's permissive marketing offers, including the credit award amounts for each offer and maximum credits allowed to be transferred to a given user, for example. The vendor software enables the vendor to create permissive marketing offers and communicate the offers to the vendor mgmt 154 and/or client 18. Accordingly, when a permissive marketing offer is accepted and a user earns a credit award, the vendor mgmt 154 may determine the appropriate award to be transferred to the user's account and transmit instructions (described above) to the credit mgmt 152 to execute the transfer (i.e., debit) from the vendor's account. The vendor mgmt 154 may keep a record of such transactions (e.g., acceptance of permissive marketing offers and rewards earned by users). These records may be used by the vendor to track performance of the vendor's permissive marketing offers and to determine permissive marketing strategy.

The payment processing module 156 (hereinafter, “payment processing”) processes user, advertiser and vendor credit purchases. User credit purchases are described above with reference to FIG. 3; advertiser and vendor credit purchases are similarly processed. If a vendor or advertiser is purchasing credits for a specific permissive marketing or other promotional offer, an advertisement or product promotion ID identifying the infomercial or other broadband content for the offer may be included with the payment information. The user ID or vendor ID and amount of credits purchased are transmitted to the payment processing 156 so that the appropriate account can be credited with the appropriate credits. The payment processing 156 transmits instructions to the credit mgmt 154 to credit the appropriate account based on this information. The payment processing 156 calculates the cost of the amount of credits purchased and generates an invoice with the cost for transmittal to the credit card company, or other payment provider (e.g., bank), with the user or vendor information obtained from the user or vendor account, including the user or vendor name and the credit card data.

The security module 158 manages the security aspects of a credit system transaction. In particular, the security module 158 generates a permissive marketing digital certificate for credit redemption, authenticates users and vendors and verifies digital signatures from the permissive marketing digital certificates, among other functions. For example, when a user performs an action requested by an advertiser or vendor in a permissive marketing offer, the user's client software 43 transmits data (i.e., an event) to the security module 158. This data may include a new hardware profile for the client 18, identification of the action performed and the amount of credits earned. The security module 158 may authenticate the user by comparing the new hardware profile to the hardware profile stored by the user account mgmt 150. Then, the security module 160 verifies the advertiser's or vendor's permissive marketing offer and the amount of credits indicated to be awarded (based on information maintained by the vendor mgmt). If the user is authenticated and the offer verified, instructions are sent to the user account mgmt 150, credit mgmt 152 and vendor mgmt 154 to transfer the credits from vendor account to user account.

The security module 158 generates permissive marketing digital certificates in response to user selecting certain permissive marketing offers. If the user selects such an offer, the user's information and information regarding the offer are communicated to the security module 158. The security module 158 authenticates the user and vendor, verifies the offer and the amount of credits and generates a permissive marketing digital certificate with the user's client 18 hardware profile. A copy of the permissive marketing digital certificate is transmitted to the user's client 18. When the user completes the action requested by the offer, the client software 43 (e.g., the credit system module 45), advertiser or vendor transmits the permissive marketing digital certificate back to the security module 158 with data indicating that the requested action has been completed. The security module 158 authenticates the permissive marketing offer as described above, validates the permissive marketing digital certificate and instructs the transfer of credits.

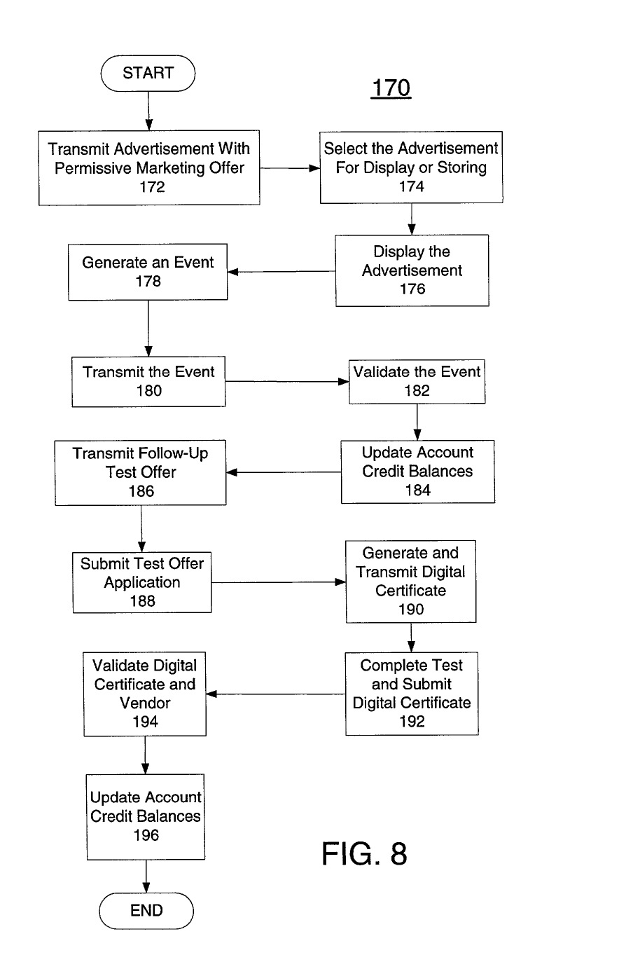

FIG. 8 illustrates an exemplary method 170 of permissive marketing, preferably processed by the credit system 75 illustrated in FIG. 7. An on-line broadband advertisement (e.g., for a Ford Mustang convertible) in which a vendor (e.g., Ford or a local Ford dealer) offers 100 credits for viewing is transmitted 172 to a client 18. The advertisement may be transmitted via any broadband content delivery means, including, for example, the system 10. The advertisement may be targeted at users who are most likely to purchase a convertible from Ford (e.g., single men, ages 22-40 who watch auto racing), as determined from user profiles, maintained by the user mgmt 150, that include a history of the user viewing.

The client 18 selects 174 the advertisement for viewing or storing (for later viewing) based on a used selection. The user may select the advertisement, for example, directly from a virtual channel 22 on which it is broadcast, from a promotional offer screen (not shown) that lists hyperlinks to one or more current promotional or permissive marketing offers, including the offer for viewing the Ford Mustang convertible advertisement, or from websites available via the Internet 26. The client 18 displays the advertisement 176 to the user. The client 18 then generates an event 178 comprising data about the permissive marketing offer and communicates the event 180 to the credit system server 58 indicating completion of the viewing. Upon receipt of the event, the credit system server 58 may prompt the client 18 for the user's account information. Alternatively, the event generated by the client 18 will include the user's account information.

The security module 158 preferably validates the event 182 by authenticating the user and vendor and verifying the vendor promotion, as described above. When this is done, the security module 158 sends the event and user information to the user account mgmt 150 and vendor mgmt 154 for account processing. The user account mgmt 150 and vendor mgmt 154 instruct the credit mgmt 152 to update the user's account and vendor's account credit balances 184.

Referring to FIG. 8, a follow-up offer may be transmitted 186 to the client 18 and presented to the user. The follow-up offer may bean additional permissive marketing offer. For example, the additional permissive marketing offer may be an offer to test-drive the Ford Mustang at a local participating dealer for an additional 500 credits. If the user selects this offer (e.g., through clicking a “yes” button displayed on a permissive marketing screen by the web browser 56), the credit system 75 may communicate (not shown) an application for an appointment (stored in the database 77) to the client 18 for display to the user (e.g., as a screen, with data fields, displayed on the web browser 56). The user fills out the application, entering requested information (e.g., name and desired appointment time), and the client 18 submits the completed application to the credit system server 58, via the Internet 26 or other communication medium. At the credit system server 58, the security module 158 verifies the permissive marketing offer referenced in the completed application. If the offer is verified, the security module 158 generates a permissive marketing digital certificate, based on information in the completed application and the permissive marketing offer (e.g., stored in the database 77), and transmits 190 the permissive marketing digital certificate back to the client 18 and/or directly to the local participating dealer.

The user test-drives the Ford Mustang, performing the second requested action, at the local dealer. The user presents the permissive marketing digital certificate (on disk, cd-rom, via email or otherwise) to the local dealer. The local dealer submits the permissive marketing digital certificate to the credit system server 58 with an indication that the second requested action (i.e., the test drive) was completed. The security module 158 validates the dealer and the permissive marketing digital certificate. If the dealer and the permissive marketing digital certificate are validated, the security module 158 approves transfer of the 500 credits to the user's account. The approval is sent to the user account mgmt 150, the vendor mgmt 154 and the credit mgmt 152 for updating the account credit balances 196 of the user and the vendor. In addition, if the user purchase the car, an additional credit award may be granted.

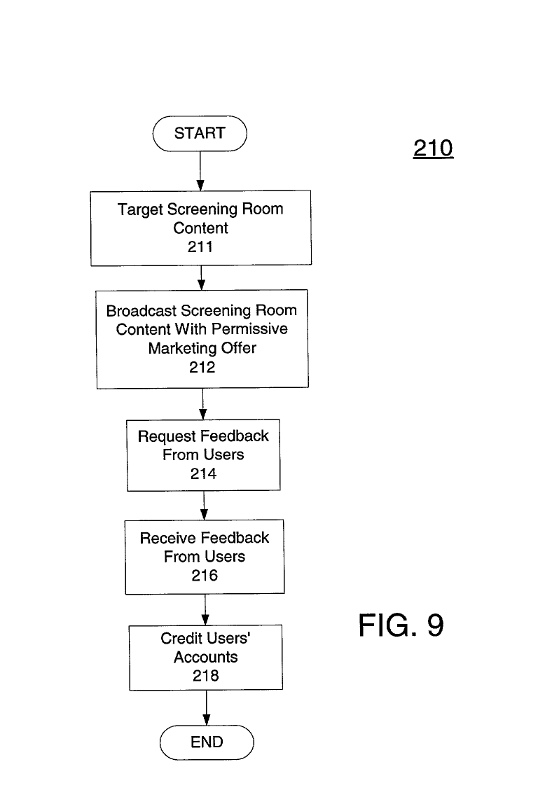

The credit system 75 enables utilization of user credit for numerous purposes, including many beyond those described above. The credit system 75 can debit or credit the user's credit for trying something (e.g., a new video game, interactive game, movie or show), providing information or watching advertisements. For example, as shown in the permissive marketing method 210 in FIG. 9, television or movie studios may setup a virtual “screening room” in which users watch (screen) a television pilot or first-cut of a movie, broadcast as a real-time stream (e.g., on a virtual channel), and provide direct feedback to the studios in exchange for credits. The studios can target the screening room to specific groups (e.g., male users between 20-30) based on the user information stored at the client services database or the user profiles. Accordingly, the method 210 shown in FIG. 9 includes the steps of: targeting screening room content 211, broadcasting screening room content (for example, to targeted groups) with a permissive marketing offer 212, requesting feedback from users 214, receiving feedback from the users 216, and crediting user accounts 218.

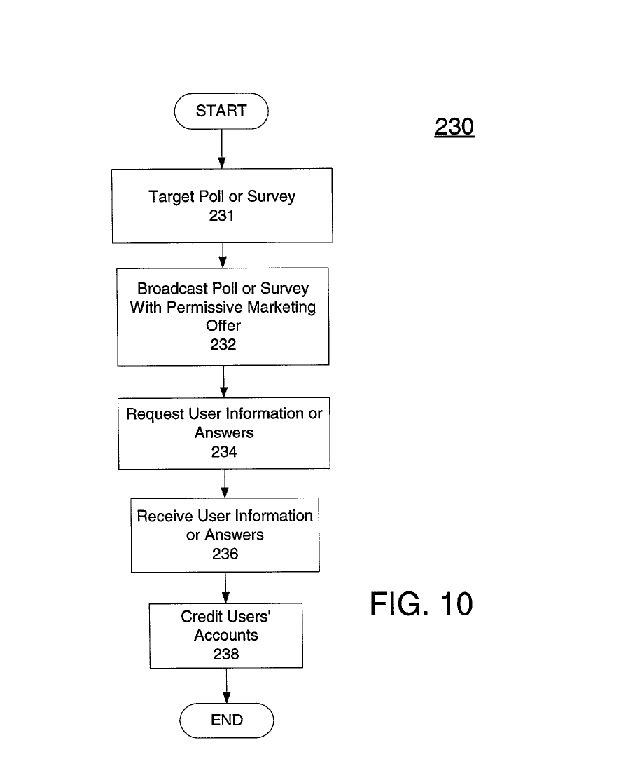

Likewise, research companies, pollsters and the like can conduct research, polls and surveys by offering credits in exchange for user information and/or answers to poll and survey questions. These offers may be made on, for example, an Information Exchange, Polling or Survey virtual channel presented to users on the web browser 56. As such, FIG. 10 illustrates an exemplary method 230 of permissive marketing comprising the steps of: targeting a poll or survey 231, broadcasting a poll or survey (for example, to targeted groups) with a permissive marketing offer 232, requesting user information or answers 234, receiving user information or answers 236, and, crediting user accounts 238.

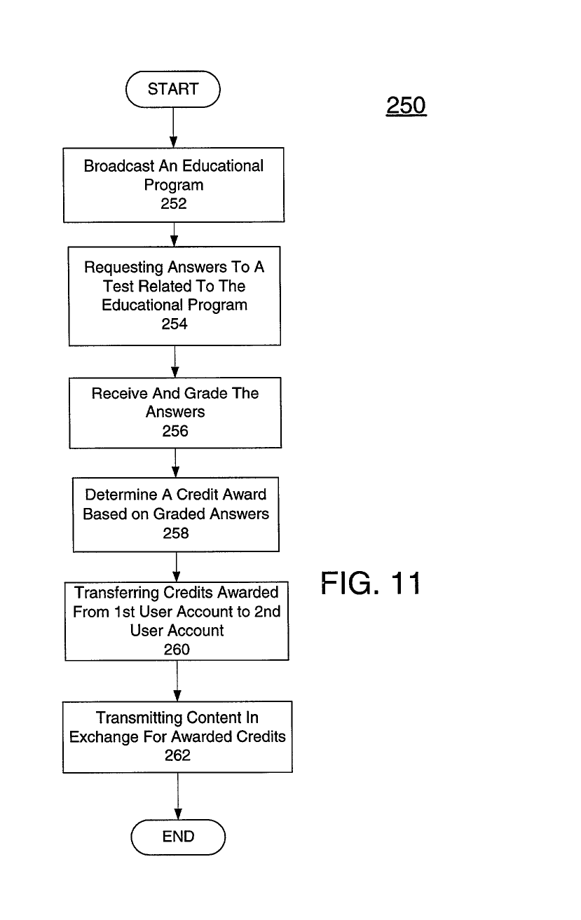

Credit awards for distance learning and educational programs may be supported by the credit system 75. For example, courses may be offered with classes or sessions broadcast as real-time streams on virtual channels. Similarly, educational programs may be broadcast as real-time streams on virtual channels. These courses and programs may be purchased with credits. Additionally, certain users, such as parents or guardians, may offer other users, such as children or wards, credits for completing courses, classes, sessions or educational programs. For example, if a child user completed watching an educational program (e.g., an interactive homework assignment) the client could generate and transmit an event that would cause credits to be transferred from the parent user's credit account to the child user's credit account, as is described above. The child user could then use this credit to purchase content such as, for example, video games or a movie. In this manner, the child user may be rewarded for completing the educational program, thereby provide incentive for the child to learn. The credit award may also be tied to how well the child user does on an interactive homework assignment, for example, increasing the credit award for each correct response. Consequently, FIG. 11 illustrates a method 250 of permissive marketing comprising the steps of: broadcasting an education program 252, requesting answers to a test related to the education program 254, receiving and grading the answers 256 (e.g., may be done automatically with correct answers stored at the database 77), determining a credit award based on the graded answers 258 (e.g., the database 77 may store a table specifying a certain number of credits per correct answer), transferring credits awarded by credit award from 1^{st} user account to 2^{nd} user account 260, and transmitting content in exchange for awarded credits 262.

Other rewards programs may be offered. For example, a frequent-viewer program may be provided. Similar to frequent-flier programs, a frequent-viewer program may allow a user to earn credits based on the number of programs they watch. For example, if a user purchases twenty PPV programs, the credit system may reward the user with credits (e.g., twenty credits). Likewise, the frequent-viewer program may be tied to other actions other than content viewed by the user. For example, if a user refers a new user to the System, the credit system may award credits (e.g., fifty credits).

In addition, credits may be deducted as a consequence of performing certain actions. For example, if a child user were to view too much non-educational content, credits may be deducted from the child user's or the parent user's account. Likewise, credits may be awarded or deducted for the non-performance of an action. For example, credits may be deducted for failure to watch an educational program, failure to virtually attend an Alcoholics Anonymous session broadcast as interactive content or failure to respond to a daily smoking or diet questionnaire. Oppositely, credits may be rewarded for not viewing non-educational programs. One user could set up their account to transfer or deduct credits for such actions or non-actions.

Moreover, credit awards may be credited in lump sums or on an incremental basis. For example, a one-hundred (100) credit award may be credited at ten (10) credits per month for ten months. Likewise, the credit award in a permissive marketing offer may simply be stated as a number of credits per time period (day, week, month, year, etc.) award.

Another implementation of the credit system 75 enables users to purchase or vendors or other third-parties (including other users) to award or give users theme or content category-related credits. For example, a user may purchase credits redeemable towards sports content, movies, or music files, or any other content category or type. Likewise, the vendors or other third-parties may award credits redeemable towards, for example, sports content, movies, or music files or any other content category or type. The theme or content category-related credits may be provided to a user in the form of a card that may include an ID number that the user can enter or which may be scanned into their client 18. The ID number is preferably tied to a file in a credit system server 58 database. The file preferably indicates how many credits are redeemable and the content category(ies) for which the credits may be redeemed. For example, a sports team may award a sports card with 100 credits redeemable for sports content to the first 10,000 attendees at a team game. The credits on the card may be recharged (i.e., additional credits may be credited/added to the card) by a third-party or another user, for example. The card may be credited due to fulfillment of a permissive marketing offer, as described above, or as a reward from another user (e.g., for getting good grades).

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. Those skilled in the art will recognize that these and other variations are possible within the spirit and scope of the invention as defined in the following claims and their equivalents.

What is claimed is:

1. A method of rewarding credits that may be used by a user to purchase multimedia content delivered to a client, comprising:
providing a permissive marketing offer, wherein the permissive marketing offer specifies a number of credits that the user will be rewarded for performance of a requested action;
the user performing the requested action;
validating performance of the requested action; and
crediting a user account with the rewarded credits, wherein the credits in the user account may be used by the user to purchase multimedia content.

2. The method of claim 1, wherein the requested action comprises the display of broadband content.

3. The method of claim 2, wherein the displayed broadband content is an infomercial.

4. The method of claim 1, further comprising:
generating an event, wherein the event provides a proof of performance of the requested action.

5. The method of claim 4, wherein the client generates the event.

6. The method of claim 4, wherein the validating further comprises the client transmitting the event to a server for verification.

7. The method of claim 1, further comprising:
generating a digital certificate, wherein the digital certificate provides a proof of performance of the requested action.

8. The method of claim 7, wherein the validating further comprises the client transmitting the digital certificate to a server for verification.

9. The method of claim 8, wherein the digital certificate is transmitted over the Internet.

10. The method of claim 1, wherein performing the requested action comprises testing of a product or service.

11. The method of claim 10, wherein the product is a car, a boat, a suit, a computer or a telephone.

12. The method of claim 1, wherein performing the requested action comprises purchasing of a product or service.

13. The method of claim 1, further comprising the user selecting the permissive marketing offer.

14. The method of claim 1, wherein the permissive marketing offer is broadcast as a real-time stream to the client.

15. The method of claim 1, wherein the permissive marketing offer is displayed on a web browser on the client.

16. The method of claim 1, wherein performing the requested action comprises viewing, on the client, an infomercial provided by an advertiser and the method further comprises:
notifying the advertiser that the infomercial has been displayed; and
transmitting a follow-up permissive marketing offer to the client.

17. The method of claim 1, wherein performing the requested action comprises viewing a real-time stream that includes a plurality of encrypted packets and the method further comprises:
he client decrypting the plurality of encrypted packets; and
the client generating an event that indicates that all of the plurality of encrypted packets has been decrypted.

18. A system comprising the client, the server, and a communication medium enables the client and the server to communicate with each other, wherein the system performs the method of claim 1.

19. A method of rewarding credits that may be used by a user to purchase multimedia content delivered to a client, comprising:
selecting a permissive marketing offer that includes an offer of a credit award in exchange for the user viewing content;
transmitting the content to the client for display;
displaying the content on the client;
the client generating an event, wherein the event is proof that the content has been displayed;
the client communicating the event to a server remote from the client;
the server validating the event; and
the server crediting the credit award to a user account.

20. The method of claim 19, wherein the content is an infomercial.

21. The method of claim 19, wherein the content is an advertisement.

22. The method of claim 19, wherein the content is provided by a third-party, the method further comprising:
the server notifying the third-party that the content has been displayed; and
transmitting, to the client, a follow-up permissive marketing offer related to the content.

23. The method of claim 22, wherein the server performs the transmitting step.

24. The method of claim 22, wherein the third-party performs the transmitting step.

25. The method of claim 22, wherein the content is an infomercial about a product and the permissive marketing offer includes an offer for a second credit award in exchange for the user testing the product.

26. The method of claim 22, wherein the permissive marketing offer is a virtual screening room offer from a third-party that requests that the user provide feedback after viewing the content, the method further comprising:
requesting feedback, wherein the feedback is the users response to the content; and
the third party receiving the feedback.

27. The method of claim 26, further comprising targeting the screening room offer to certain users based on user profiles.

28. The method of claim 22, wherein the permissive marketing offer is a poll offer that offers the credit award in exchange for the user providing requested user answers in response to a poll, the method further comprising:
requesting user answers in response to the poll; and
receiving the user answers.

29. The method of claim 28, further comprising targeting the poll offer to certain users based on user profiles.

30. A method of rewarding credits that may be used by a user to purchase multimedia content delivered to a client, comprising:
broadcasting an educational program, wherein the educational program specifies a number of credits that may be earned by a first user;
displaying the educational program; and
transferring the specified number of credits from a second user account to a first user account so that the first user may use the credits to purchase multimedia content.

31. The method of claim 30, wherein the specified number of credits is conditional on a grade achieved by the first user, further comprising:
requesting answers from the first user to questions posed in the educational program;
grading the answers; and
determining the number of credits earned by the first user based on the grade.

32. A computer-readable medium comprising instructions for rewarding credits that may be used by a user to purchase multimedia content delivered to a client, by:
displaying a permissive marketing offer, wherein the permissive marketing offer specifies a number of credits that the user will be rewarded for performance of a requested action;
generating an event, wherein the event indicates that the user has performed the requested action; and
transmitting the event to a server for validation of the event and rewarding of the specified number of credits to a user account.

33. The computer-readable medium of claim 32, wherein the requested action includes the user viewing content, the computer-readable medium further comprising instructions for:
displaying the content on the client, wherein completing the displaying step triggers execution of the generating instruction.

33. The computer-readable medium of claim 32, further comprising instructions for:
the client receiving proof from the user that the user has performed the requested action, wherein the client receiving proof from the user triggers execution of the generating instruction.

34. The computer-readable medium of claim 33, wherein the received proof is a digital certificate and the generating instruction generates an event that includes the digital certificate.

35. A computer-readable medium comprising instructions for rewarding credits that may be used by a user to purchase multimedia content delivered by a server, by:
transmitting a permissive marketing offer to a client, wherein the permissive marketing offer specifies a number of credits that the user will be rewarded for performance of a requested action;
receiving an event, wherein the event indicates that the user has performed the requested action; and
validating the event, whereby the authenticity of the event is verified; and
rewarding the specified number of credits to a user account.

36. The computer-readable medium of claim 35, further comprising instructions for:
transmitting a second permissive marketing offer to the client, wherein the second permissive marketing offer specifies a second number of credits that the user will be rewarded for performance of a second requested action.

37. The computer-readable medium of claim 35, further comprising instructions for:
transmitting a communication to a third-party that provided the permissive marketing offer, wherein the communication indicates that the user has performed the requested action.

38. A card for use in a multimedia content delivery system that delivers multimedia content to clients and in which credits may be used by a user to purchase multimedia content for viewing, the card including:
a balance of credits, maintained in electronic form, that indicates how many credits that are available to the user for purchasing multimedia content; and
a ID number that identifies the card.

39. The card of claim 38 wherein the credits in the balance of credits may only be used to purchase multimedia content from a category of content.
